(19) United States
(12) Patent Application Publication
(10) Pub. No.: US 2014/0341709 A1
(43) Pub. Date: Nov. 20, 2014

(54) DOUBLE IMPULSE TURBINE SYSTEM

(71) Applicant: Innocent Hervé Yamodo, Cambridge, MA (US)

(72) Inventor: Innocent Hervé Yamodo, Cambridge, MA (US)

(73) Assignee: Innocent Hervé Yamodo, Cambridge, MA (US)

(21) Appl. No.: 14/083,447

(22) Filed: Nov. 19, 2013

Related U.S. Application Data
(60) Provisional application No. 61/727,748, filed on Nov. 19, 2012.
(60) Provisional application No. 61/865,337, filed on Aug. 13, 2013.

(51) Int. Cl. F01D 15/10

(52) U.S. Cl. CPC F01D 15/10; F05D 2220/76
USPC 415/60

(57) ABSTRACT

A double impulse turbine system to convert the energy of flowing fluid into electricity is provided. The system takes fully advantage of the high efficiency and compactness provided by contra-rotating permanent magnet generators to produce electricity. It is composed of two impulse turbines, rotating in opposite directions and coaxially connected to a central contra-rotating generator. In function, a fluid flow is divided into secondary flows oriented directly and tangentially toward the turbines for a maximum energy transfer. The system comes with turbines having different bucket designs adapted for uses in particular environments. Special housings or turbine chambers are designed to carry the turbines and enable the conversion of the energy of a fluid flowing in pipes into electricity. This double impulse turbine system can be used to convert into electricity the energy of any fluid flowing in-pipe as a flow or as a jet. It is provided to be used in and out urban environments in water supply distribution and wastewater piping systems or hydroelectric plants in different conditions, such as presence or not of floating debris, flow rate or pressure.

This application claims priority of U.S. Provisional App. No. 61/727,748 “MULTIDIRECTIONAL TURBINE SYSTEM” filed Nov. 19, 2012 and U.S. Provisional App. No. 61/865,337 “DOUBLE IMPULSE TURBINE SYSTEM” filed Aug. 13, 2013.

### FIELD OF THE INVENTION

The present invention relates to a new turbine system using contra rotating generator, more particularly, a hydroelectric turbine with any of a number of characteristics, most particularly designs in which a water flow is divided into secondary flows oriented toward turbines rotating in opposite directions.

### DESCRIPTION OF PRIOR ART

The present invention relates to a hydroelectric turbine, particularly a system with twin turbines mounted side by side and rotating in opposite directions actuated by water running in a confined space, such as a pipe, or by airborne pressurized water jets. There are unique challenges in designing blades for turbines in general and in piping systems in particular. The same challenges also have to be put in the designing the casings of such turbine systems for harnessing energy from fluids running in pipe systems. Several in-pipe turbine systems are in development or use based on using turbines with ball foil blades or conventional turbines. However, these options suffer from the fact that because the particular design of their turbines, they are vulnerable to clogging by debris or have low efficiency. Until last decade, turbine systems used to be a runner of different shapes or designs connected to the magnetic field rotor of a generator spinning inside a coil stator to generate electric power. Recently, contra-rotating generators emerged to generate higher electric power at low speed of operation. In this type of generator, a cylindrical armature is supported on an inner shaft rotating in a first direction while the cylindrical magnetic field rotor is supported on an outer shaft. The outer shaft is oriented coaxially to the inner shaft and rotates opposite to the first direction. Therefore, for a given flow, the relative rotational or angular velocity of the rotor and contra rotating stator is twice compared to a conventional generator where only the rotor is rotating in a steady stator. Contra-rotating generators have been successfully used with wind turbines. Despite turbulence induced by the proximity of two impellers rotating in opposite directions, it has been shown that a contra rotating generator improves up to 40% the electric production of a wind turbine compared to a similar conventional system with a single impeller and conventional generator. The concept has been adapted for hydroelectricity in open stream by companies like nautricity with its CoRMat generator. However, the adaptations of contra rotating hydroelectric generators for in-pipe use are still at the bench laboratory stage or computer simulation. The available literatures indicate that all these attempts are performed with turbines with axial impellers and that most of the pressure energy of the water flowing in the pipe is used by the front runner. Despite promising efficiency increases observed with in-pipe contra rotating hydroelectric generators with axial impellers, the turbulence issue and the vulnerability to clogging makes problematic the adaptation of this configuration to real environment. For all these reason, there is a need for an efficient and reliable in-pipe hydroelectric generator taking fully advantage of the high potential of the contra rotating generator to convert the energy of a flowing fluid in-pipe into electric power.

### BACKGROUND OF THE INVENTION

All available data suggest a rapid growth of inhabitants in urban areas worldwide in the coming decades. Such growth, associated with the need for clean energy, will require innovative in-situ energy supply sources. One of energy sources available, ready to use and virtually untapped is the energy of water running in pipelines in and out of urban areas. Contra rotating generators with permanent magnet associates high torque, density and efficiency with compactness and low starting torque. These features make them well suited for application in urban areas. Used on wind turbines, contra rotating generators increase the electricity production. Presently, the energy of water flowing in pipes in urban areas is virtually untapped or wasted by dissipation with pressure reduction valves. A double impulse turbine system is proposed to harness this energy and convert it into electricity.

### SUMMARY OF INVENTION

The present invention is a turbine system using twin impulse turbines rotating in opposite directions and coaxially connected to the rotor and contra rotating coil stator of a contra rotating generator centrally positioned. For pipe connection use, the system includes an inlet “Y” connector to be attached to the inlets of the housings carrying the turbines and an outlet “Y” discharge collector. The inlet “Y” connector ends are attached to the inlet of housing carrying the turbines so the incoming flow is divided equally into secondary flows toward each turbine installed in their respective housing. The outlet “Y” discharge collector, attached to the outlet of the housings carrying the turbines, merges the fluid flows which passed the turbines into a single tail flow. The turbines are actuated by fluid moving through the pipeline and thus transmit the water energy to the contra rotating generator to produce electric power. For high pressure jet use, the ends of the inlet “Y” connector are prolonged by nozzles delivering jet flows tangentially toward the turbines. The turbines are actuated by jet flows hitting their buckets and the water energy is transmitted to the contra rotating generator to produce electric power.

Another aspect of the invention provides that the turbine for pipe use has horn-like shape with smooth body surface and closed by a semi spherical concave inlet. The buckets are inserted into each other in such way that the end of previous bucket is positioned at the entrance of the inlet of the following one.

Another aspect of the invention provides that the turbine for pipe use has horn-like shape with scaled body surface and closed by a semi spherical concave inlet. The buckets are inserted into each other in such way that the end of previous bucket is positioned at the entrance of the inlet of the following one.

Another aspect of the invention provides that the turbine for pipe use has horn-like shape with secondary inlets on top body surface and a small outlet. These open buckets are inserted into each other in such way that the small outlet of previous bucket is positioned at the entrance of the inlet of the following one.

Another aspect of the invention provides that the housings carrying the turbines for pipe uses are in different shapes or designs adapted for use with liquid or gaseous fluids in divers configurations.

Another aspect of the invention provides that the system could be compact and directly attached to a pipe line. The inlet of the system is attached to two internal pipes connected to the housings carrying the turbines that are coaxially connected to the contra rotating turbine positioned between them.

Another aspect of the invention provides that the jet turbine has buckets deflecting the jet flow into two parts and radially. The jet flow hits the surface of bucket inlet perpendicularly and is deflected smoothly and backwardly.

### BRIEF DESCRIPTION OF DRAWINGS

The double impulse turbine system invention will be better understood and objects other than those set forth above will become apparent when consideration is given to the following detailed description thereof. Such description makes reference to the annexed drawings wherein:

FIG. 1 shows front (A), isomeric (B), top (C) and side (D) views of a smooth horn-bucket while the FIG. 1(E) shows a transversal cut of the bucket.

FIG. 2 shows side (A), front (B) and isomeric (C) view of a turbine with smooth horn-buckets.

FIG. 3 shows front (A), isomeric (B), top (C) and side (D) views of a scaled horn-bucket while the FIG. 3(E) shows a transversal cut of the bucket.

FIG. 4 shows side (A), front (B) and isomeric (C) view of a turbine with scaled horn-buckets.

FIG. 5 shows front (A), isomeric (B), top (C) and side (D) views of an open horn-bucket while the FIG. 5E shows a transversal cut of the bucket.

FIG. 6 shows side (A), front (B) and isomeric (C) view of a turbine with open horn-buckets.

FIG. 7 shows side (A), front (B) and isomeric (C) view of a double impulse turbine system with scaled horn-bucket turbines.

FIG. 8 shows different housings designed to carry the turbine used to harness the energy of fluid flowing in pipe; straight (A), right angle low outlet (B), anti-parallel (C) and right angle high outlet (D) configurations.

FIG. 9 shows front (A) and isomeric (B) views of a straight turbine housing with the two halves open while the FIG. 9(C) shows a side view of a half right housing carrying a turbine.

FIG. 10 shows a cross section of the body of a straight turbine housing (A) and isomeric views of straight (B), right angle low outlet (C), anti-parallel (D) and right angle high outlet (E) housings in double impulse turbine system configurations.

FIG. 11 shows isomeric views of straight housings in double impulse turbine system configurations before (A) and after (B) connection to “Y” connectors.

FIG. 12 shows front (A), isomeric (B), side (C) and top (D) views of straight housings in double impulse turbine system configurations attached to “Y” connectors depicting the path of the fluid through the system.

FIG. 13 shows top (A and B), side (C and D) and isomeric (E and F) views of a compact version of a double impulse turbine system. The FIG. 13(A), FIG. 13(C) and FIG. 13(E) are transparent views of the compact version of the double impulse turbine system while the FIG. 13(B), FIG. 13(D) and FIG. 13(F) show external views. The FIG. 13(G) and FIG. 13(H) show the front and back of the double impulse turbine system respectively.

FIG. 14 shows isomeric (A), side (B), front (C), back (D) and top (E) views of a cup bucket of a water jet turbine.

FIG. 15 shows side (A) and front (B) views of a bucket of a water jet turbine illustrating its design features and the path of deflected water jet. The FIG. 15(C) and FIG. 15(D) show respectively side and front views of two adjacent cup buckets in function.

FIG. 16 shows the steps of installation of a cup bucket on the turbine rim. The FIG. 16(A) and FIG. 16(C) show respectively front and side views of a cup bucket before installation while the FIG. 16(B) and FIG. 16(D) show respectively front and side views of the installed cup bucket.

FIG. 17 shows an exploded (A) and an assembled (B) isomeric views of a jet impulse turbine. The FIG. 17(C) and FIG. 17(D) show respectively a side and a front views of the assembled turbine.

FIG. 18 shows front (A), isomeric (B) and side (C) views of a double impulse turbine system with jet turbines.

In addition of these black and white mandatory drawings, additional non-black and white or color drawings are added to this application to make the invention more understandable.

### DETAILED DESCRIPTION OF THE INVENTION

Definitions:

“Double impulse turbine system” refers to two turbines rotating in opposite directions connected the power-producing component and to the magnetic field component of a contra rotating electric generator where the actuating fluid is oriented directly toward the turbine buckets.

“Contra rotating generator” refers to an electric generator where the power-producing component or armature and the magnetic field component are both rotating in opposite directions. The terms “rotor” and “contra rotating rotor” refer alternatively to the power-producing component and to the magnetic field component of a contra rotating generator with their respective drive shaft.

“Inlet connector pipe” has to be understood as piping system merging two or more pipes to bring tangentially a fluid flow toward the inlets of a turbine installed inside a turbine housing.

“Outlet connector pipe” has to be understood as piping system merging flow discharged from two or more turbine housings into a single fluid flow.

“Fluid” refers to any liquid or gas. “Water” should be understood only as the most common example of a fluid. Therefore all references to water include any type of fluid including water, oil or gas unless otherwise specified.

“Bucket” has to be understood as turbine “vane” or “sail” where the energy of the fluid is captured and converted into turbine drive shaft torque transmitted to an electric generator to produce electric power.

“Housing” has to be understood as “casing” or “chamber” carrying a turbine and orienting the fluid flow toward the buckets of the turbine installed inside.

“Connecting systems” refers to mechanisms enabling to connect directly, through a gear box or a drive belt a turbine drive shaft to the drive shafts of the power-producing and magnetic field components of a contra rotating generator.

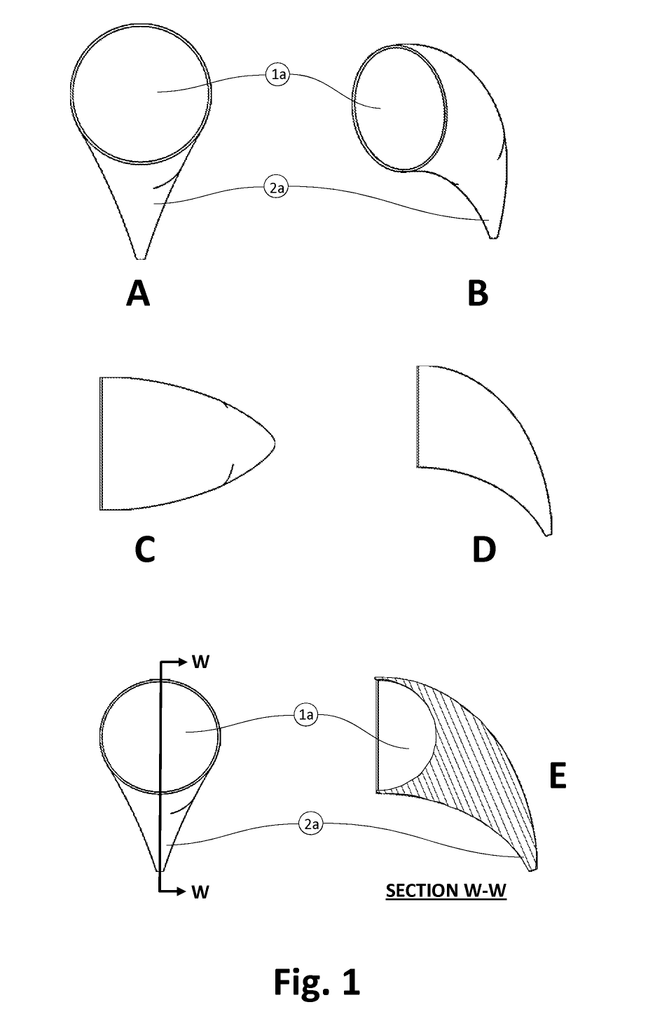

With reference now to the drawings, and in particular to FIGS. 1 through 18 thereof, double impulse turbine system embodying the principles and concepts of the present invention will be described. Additionally, optional non-black and white drawings are also used for this purpose.

To help better understand the present double impulse turbine system, it will be described in the following paragraphs. The description will paint the fundamental principle of the invention followed by a general description of possible embodiments. The description will also describe accessories designed to improve the efficiency of the turbine or its use in particular configurations.

The fundamental principle of the present invention is in using oriented fluid flow toward the buckets of twin turbines rotating in opposite directions and coaxially connected to a contra rotating generator. The system is adaptable to convert the energy of water flowing in a pipe or as a jet flow into electric energy. For the conversion of energy of water flowing in pipe into electricity, three different turbine buckets have been designed to fit particular configuration uses; a smooth horn-bucket, a scaled horn-bucket and an open horn-bucket.

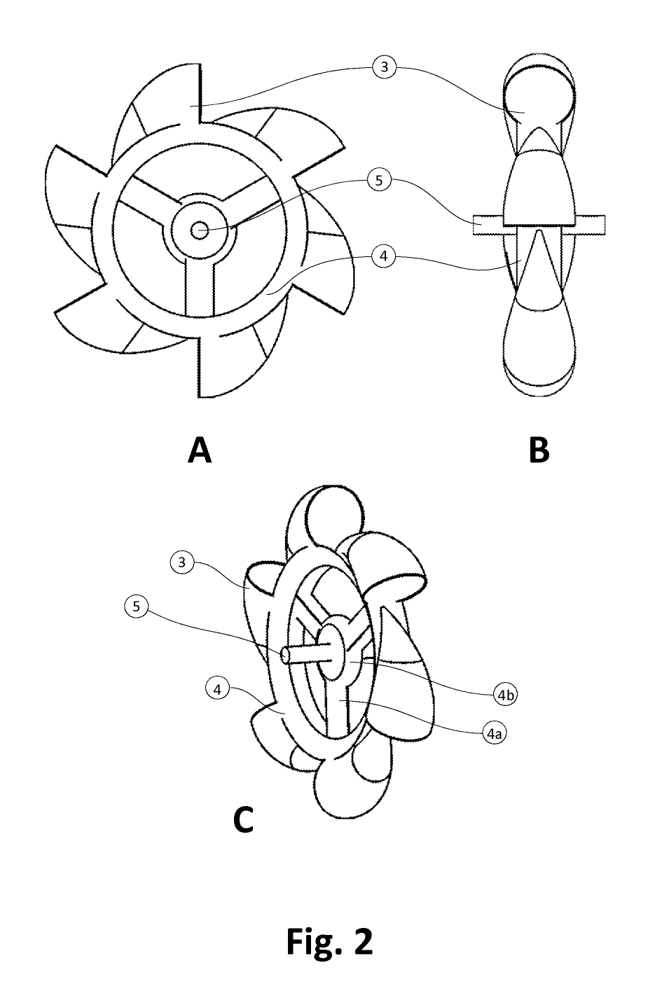

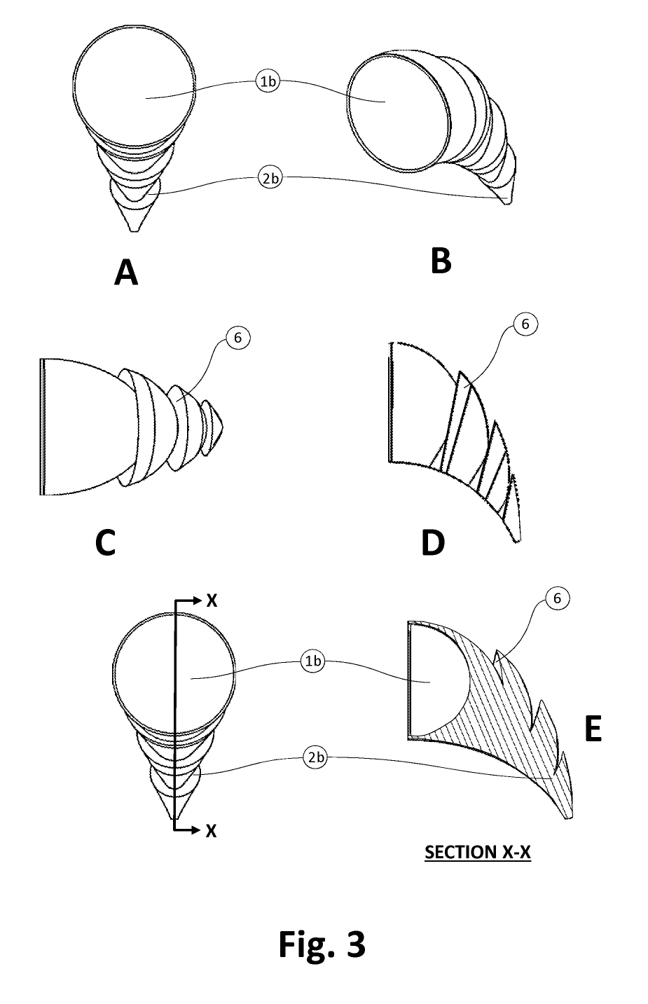

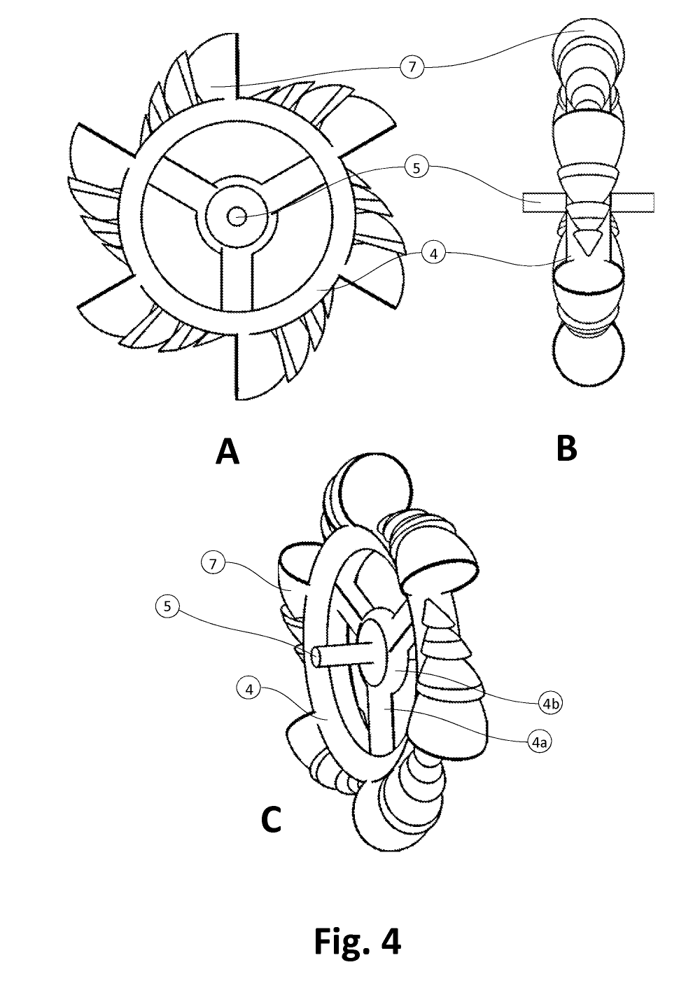

A smooth horn-bucket to be used on smooth horn-bucket turbine is disclosed in the FIG. 1 where the circularity of the inlet (1a) is illustrated in a front (A) and isomeric (B) views. The circular inlet is prolonged by a smooth, elongated and curved horn shaped body (2a) as illustrated in the top (C) and side (D) views. The longitudinal cross section cut view (E) of the bucket in this figure depicts the semi spherical and concave shape of the inlet. This bucket is designed to be mounted on a rim of a turbine as shown in FIG. 2. The turbine is further disclosed in a side (A), front (B) and isomeric (C) views. As shown, the smooth horn-buckets (3) are mounted in such way that their circular inlet mouths are in planes containing the shaft or the central rotational axis of the turbine. The buckets are aligned regularly around the turbine rim (4) in a plane crossing its middle and the end of each bucket is positioned near the inlet of the following one. The turbine central drive shaft (5) is connected to the rim (4) by spokes (4a) with triangular cross section and tapered edges through a central hub (4b). This turbine is designed to be used to harness the energy of water flowing in pipe without being clogged by debris. The horn-like shape of the turbine buckets reduces the drag of the fluid on the bucket surfaces during the rotation of the turbine. In contrary, the semi spherical concave inlet of the bucket fits with circular cross section of pipe carrying the fluid flow enables a maximum capture of the energy of the fluid flowing in a pipe. More, because the body of the horn-like shaped bucket is filed, turbines with such buckets are hard to be broken and so, particularly well-suited to be used for pipe system carrying wastewater with floating debris. To improve the efficiency of such turbine, another horn-shaped bucket has been designed. As disclosed in the FIG. 3 showing a front (A), isomeric (B), top (C) and side (D) views, the scaled horn-shaped bucket is similar to the smooth horn-bucket except that its body surface (2b) has scales (6) with their edges oriented toward the front and main inlet (1b). The longitudinal cross section (E) view of the bucket in this figure depicts the semi spherical and concave shape of the inlet as for the smooth horn-bucket described above and the orientation of the body scales (6). This design could be considered as several smooth horn-buckets with decreasing sizes inserted into each other. Because the surface of the scaled horn-bucket is like secondary inlets, such bucket can catch not only the incoming flow facing the bucket main circular inlet (1b) but also the fluid flow hitting the top surface of the buckets during the turbine rotation. Therefore, a single bucket behaves as several buckets with decreasing sizes and inserted into each other. The FIG. 4 depicts a turbine with such buckets in side (A), front (B) and isomeric (D) views. The disposition of the buckets is similar to a smooth horn-bucket turbine. The scaled horn-buckets (7) are mounted on the periphery of the turbine rim (4) of the turbine. The turbine shaft (5) is connected to the rim (4) by spokes (4a) with triangular cross section and tapered edges through a central hub (4b). Because the particular design of its buckets, the scaled horn-bucket turbine is designed to be used to harness the energy of water flowing in pipe with reduced velocity. The disposition and orientation of the scales (8) on the bucket enables the capture of more fluid flow and thus provide more torque to the turbine. As for the smooth horn-bucket turbine, the buckets of the scaled horn-bucket turbine are also closed. Therefore, this type of turbine can be used also to convert the energy of wastewater flowing in pipes without being clogged by debris. It has to be noted that although the smooth and scaled horn-bucket turbines were designed to be clogging proof and so be used to harness the energy of wastewater flowing in pipe, they can be used also for clean water as long it flows in pipe.

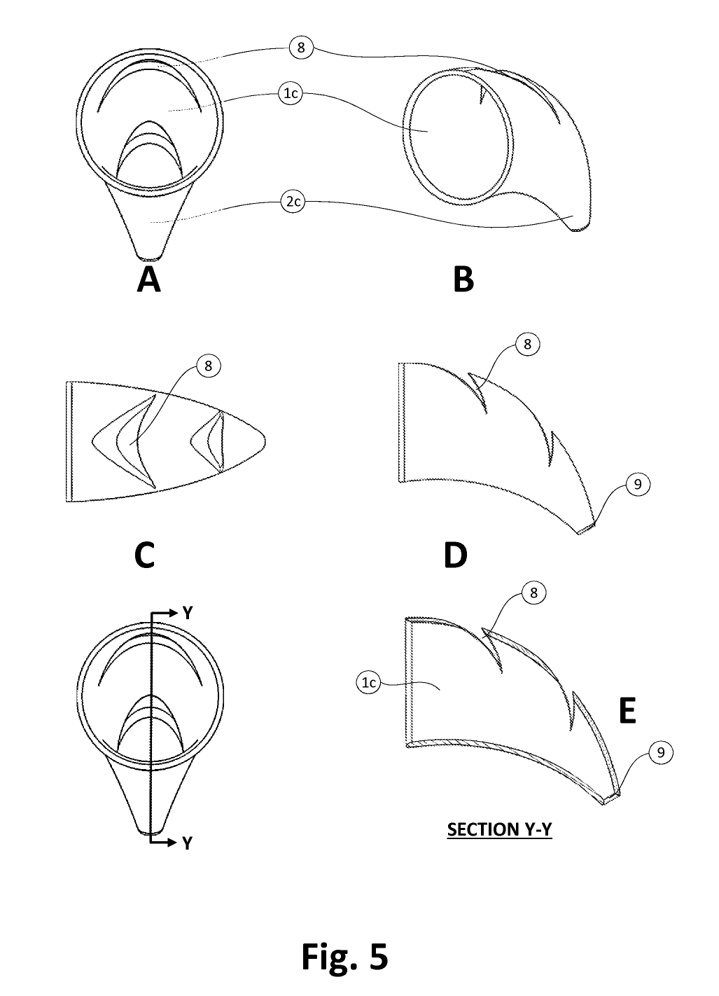

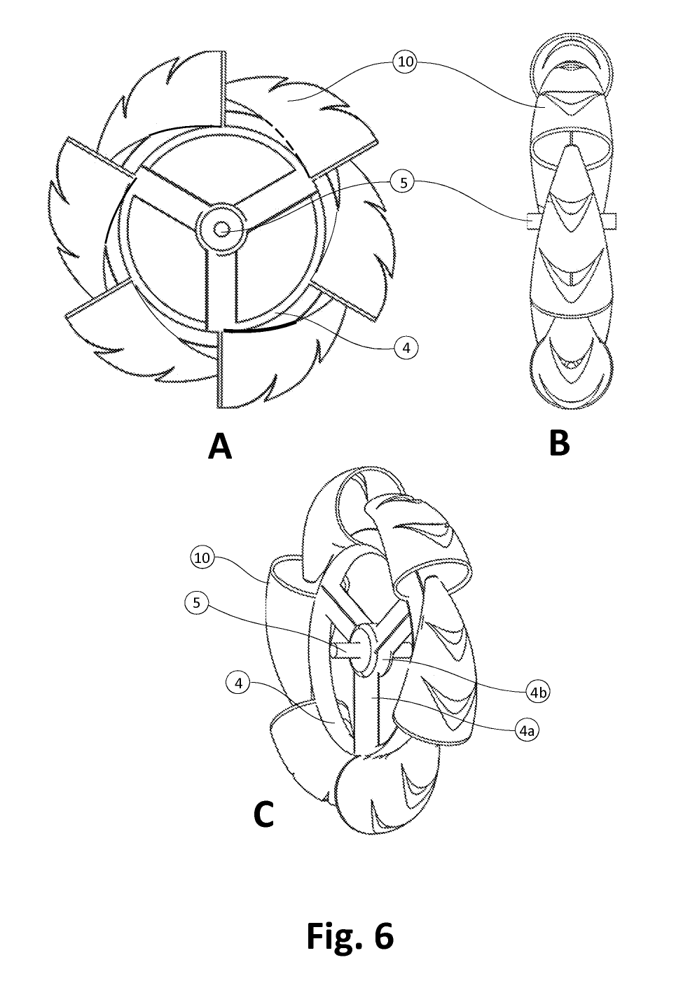

A third type of turbine to be used with clean water flowing in pipe is disclosed. A bucket of this turbine is disclosed in the FIG. 5 showing a front (A), isomeric (B), top (C) and side (D) views. In contrary to the two previous buckets disclosed above, in this bucket named “open horn-bucket”, the inlet is not closed but communicates with a small circular outlet at the other end of the bucket. These views reveal the circular inlet (1c) and horn-shaped body (2c) of the bucket. More importantly, they show secondary inlets (8) located on the dorsal face of the bucket. These secondary inlets are crescent-like openings to enable fluid flow to enter into the bucket before the main inlet (1c) faces the incoming flow during the rotation of a turbine on which they are mounted. Thus, the flow enters into the main inlet (1c) and secondary inlets (8) and exit by the small outlet (9) of the bucket. A transversal cut of this bucket is shows by the FIG. 5(E) where the relative locations of the inlet (1c), secondary inlet (8) and outlet (9) are illustrated. This view, as the side view (B), depicts also the horn-like shape of the open horn-bucket and the small size of the outlet (9) compared to the size of the inlet (1c). A turbine with open horn-buckets is disclosed in the FIG. 6 showing side (A), front (B) and isomeric (C) views. The open horn-buckets (10) are mounted on the outer periphery of the rim (4) of the turbine with their circular inlet mouths in planes containing the shaft (5) or the central rotational axis of the turbine. As for the previous turbines, the buckets are aligned regularly around the turbine rim (4) in a middle crossing plane. For this turbine, the smaller outlet end of each bucket is inserted into the bigger opening inlet of the following bucket. The outlets (9) are precisely positioned at the center of the following inlets (1c). In use, this configuration enables the fluid flow to enter permanently inside the turbine buckets. Because these buckets are empty or hollow, the turbines with such buckets are light and so will have a lower starting torque compared to the turbines presented above. The open horn-bucket turbine is designed to be used for clean water like the water flowing in municipal drinking water supply pipe systems or recycled water pipe systems. The addition of the supplementary dorsal inlets to the buckets distinguishes the design from previous turbines using horn-like or conical buckets. Overall, the bucket designs disclosed here provide improvements compared to existing or previous bucket designs. To extract energy from flowing fluids, several designs and approaches including propeller blades, cups, bowls, and flat blades have been proposed. Thus, several conical bucket designs have been attempted for turbines to extract energy of moving fluids. Among these attempts, the most notable are; the wind motors of Max Harris disclosed in the U.S. Pat. No. 196,448 in October 1877, the Ogden turbine of Russell R. Ogden disclosed in the U.S. Pat. No. 335,713 in February 1886, the kinnley wind turbine disclosed in the U.S. Pat. No. 854,652 by William J Kinney in May 1907, the wind driven apparatus proposed by George J. Bunzer in the U.S. Pat. No. 4,019,828 in April 1977, the wind energy machine disclosed in May 1982 by Robert W. Willmouth in the U.S. Pat. No. 4,329,593, the wind power converter of August Tornquist published in the U.S. Pat. No. 4,364,709 in December 1982 or the windmill rotor design of Richard H. Miller in U.S. Des. Pat. No. 336,762. The main weakness of these turbine design approaches using conical buckets mount around a circular rim resides in the fact that the surface collecting the energy of the wind is relatively small compared to the surface covered by the blades of turbine using propellers. Therefore, such approaches cannot compete with turbines with axial propeller blades in harnessing the energy of flowing fluid in open environment. However, in enclosed environment such as a cylindrical pipe where the fluid flow is oriented directly toward the turbine buckets, the conical shape presents the advantage to have its circular inlet fitting ideally to the circular cross section of the pipe. This enables a maximum thrust of the fluid on the turbine buckets. This option was adopted by Leviathan Energy Hydroelectric Ltd company for the buckets of its in pipe hydroelectric generator disclosed in the US patent No 20130129495 A1 in May 2013. The buckets disclosed in this patent are just cups, conical with cup or propeller blades. Except in the wind motors of Max Harris disclosed in the U.S. Pat. No. 196,448, none of the bucket designs disclosed in the patents mentioned above are shaped as a horn with a bent body. This bending enables the bucket bodies to follow the curve of the rim on which they are mounted. This reduces turbulences and frictions of the fluid on the bucket bodies during the rotation of the turbine. More importantly, when the bucket is hollow with a large inlet communicating with a small outlet, the bending enables the flow entering into the bucket to be deflected around the rim which gives an additional torque to the turbine. Semi-spherical cup buckets have the advantage to fit in the circular cross section of a pipe. However, this shape generates also high turbulence when traveling in a fluid. To overcome these issues, the solution is to merge the semi-spherical cup inlet with a horn-shaped body for the bucket design. The FIG. 4 and FIG. 6 show turbines with smooth horn-buckets and scaled horn-buckets respectively. The buckets of these turbines associate horn shape and semi-spherical concave cup inlet. This makes these turbines ideal to extract energy of water flowing in pipe. In contrary to in-pipe turbine using spherical airfoil blade like the in-pipe hydroelectric power system and turbine such the one disclosed in the U.S. Pat. No. 7,959,411 B2, this particular design make turbines with horn shaped body and semi-spherical concave cup inlet more resistant to clogging or impacts from debris in wastewater running inside the pipe. Therefore, these bucket designs, associating cup inlet with horn shaped smooth or scaled surface body, provide efficiency and reliability to turbines used to harness the energy of wastewater flowing in a pipe. The buckets of the wind motor disclosed in the U.S. Pat. No. 196,448 have a hollow horn-like body with a big circular inlet communicating with a small outlet. Because the buckets are inserted into each other, all buckets of the turbine are in permanent communication. Thus, the fluid flow entering in a bucket inlet is communicated permanently to all other buckets. As said above, this configuration was not adapted to harness efficiently the energy of a wind compared to turbine using propeller-like blades because of the small surface covered by the inlet of the buckets. However, this bucket design is more adapted for turbine used to extract the energy of fluid flowing in a pipe. An improvement of this bucket design is disclosed consisting in the addition of more inlets on the dorsal surface of the bucket as shown in the FIG. 5. When these buckets are mounted on a turbine, as shown in the FIG. 6, these secondary inlets enable the fluid flow to enter into a bucket before the main circular inlet face the incoming flow. In a result, the amount of fluid entering into each bucket is increased and so, the efficiency of the turbine.

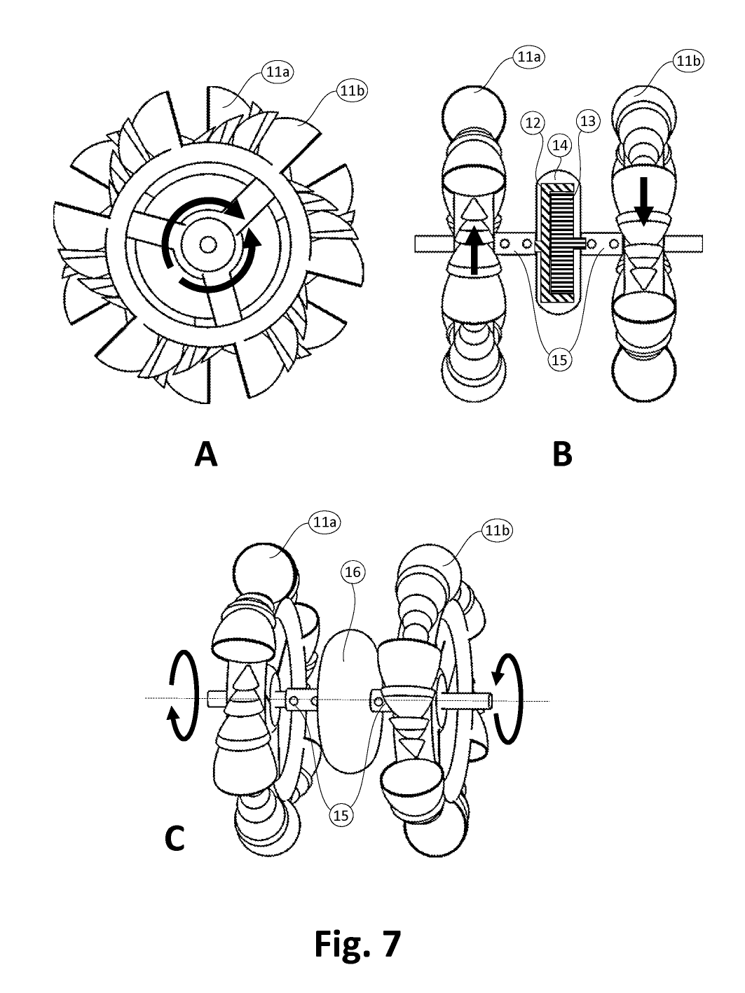

Although the turbines disclosed above can be used with conventional generator, the scope of the invention disclosed here is the adaptation of a contra rotating generator to a hydroelectric generator in a configuration named “double impulse turbine system”. The FIG. 7 shows a side (A), front (B) and isomeric (C) views of scaled horn-bucket turbines assembled in a double impulse turbine system configuration. As depicted in this figure, this configuration includes two turbines (11a and 11b) coaxially connected, in opposite directions, to the shaft of the power-producing component (12) and contra rotating magnetic field component (13) of a contra rotating generator enclosed inside a housing (14). The coaxial connection of the turbines to the contra rotating generator is provided by two connectors (15). It has to be noted that the connection of the turbine shafts to the shafts of the contra rotating shafts can be direct, through gears or belts to equalize or regulate the rotational speeds of the rotating parts of the contra rotating generator. As illustrated by the dark bold arrows, in function, the turbines (11), coaxially connected to a centrally positioned contra rotating generator (16), rotate in opposite directions to each other. In a conventional electrical generator, a rotor spins in a stationary stator resulting in the production of an electric power. In contra rotating generator in contrary, both parts rotates but in opposite directions. In result, the relative angular rotational speed of these parts to each other is doubled. Because the amount of electricity produced by a generator is related to this rotational speed, a contra rotating generator can produce twice more electricity than a conventional generator when used on similar turbines in identical conditions. Because the turbines attached to a contra rotating generator spin in opposite directions, the reactive torque on the supporting framework produced by the rotation of each set is cancelled by the rotation of the other. Finally, when used on wind turbines, a contra rotating generator enables the reduction of the size of blade propellers and so the weight and cost of the structure. Depending the architecture and composition of the parts, a contra rotating generator can operate at high revolution rates and temperature as in the model disclosed in the patent US2006/0163963 A1, or increase the relative magnetic flux speed for generating electrical power at low speeds of operation as disclosed in the patent US20080211236 A1. Thus, a contra rotating generator could be used for a variety of needs in term of rotational speed, temperature control or electric production. A study performed at the University of Bristol in United Kingdom has shown that a contra rotating generator can reach 94% of efficiency at contra rotating speed of 500 rpm (a).

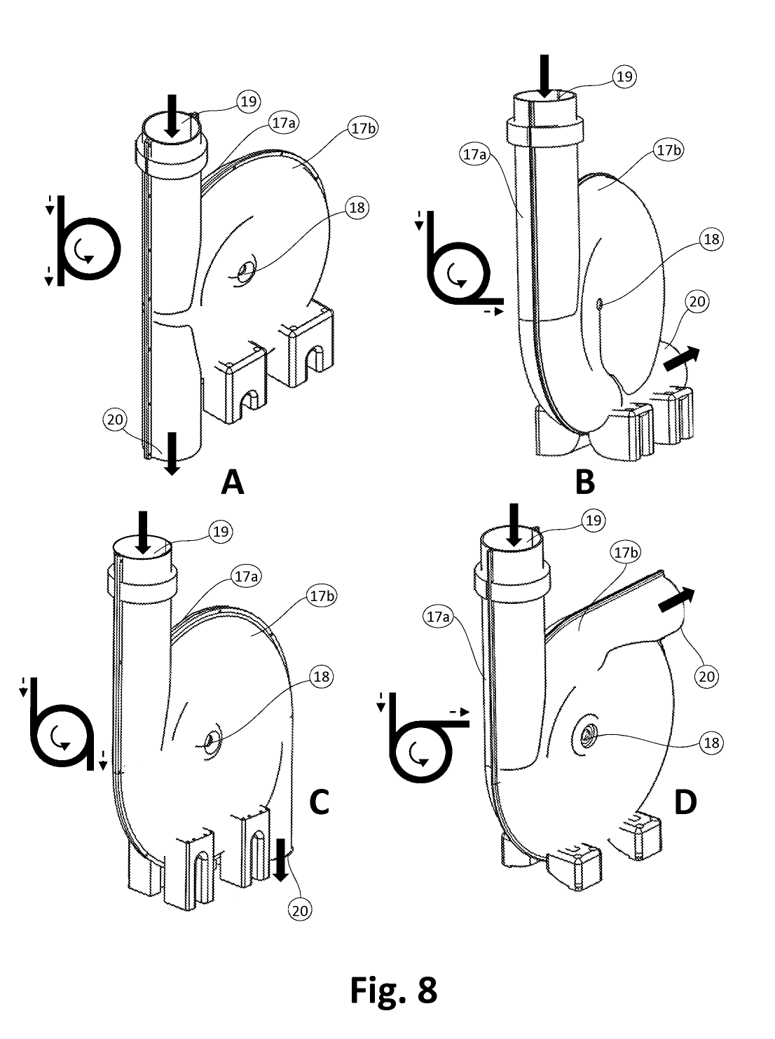

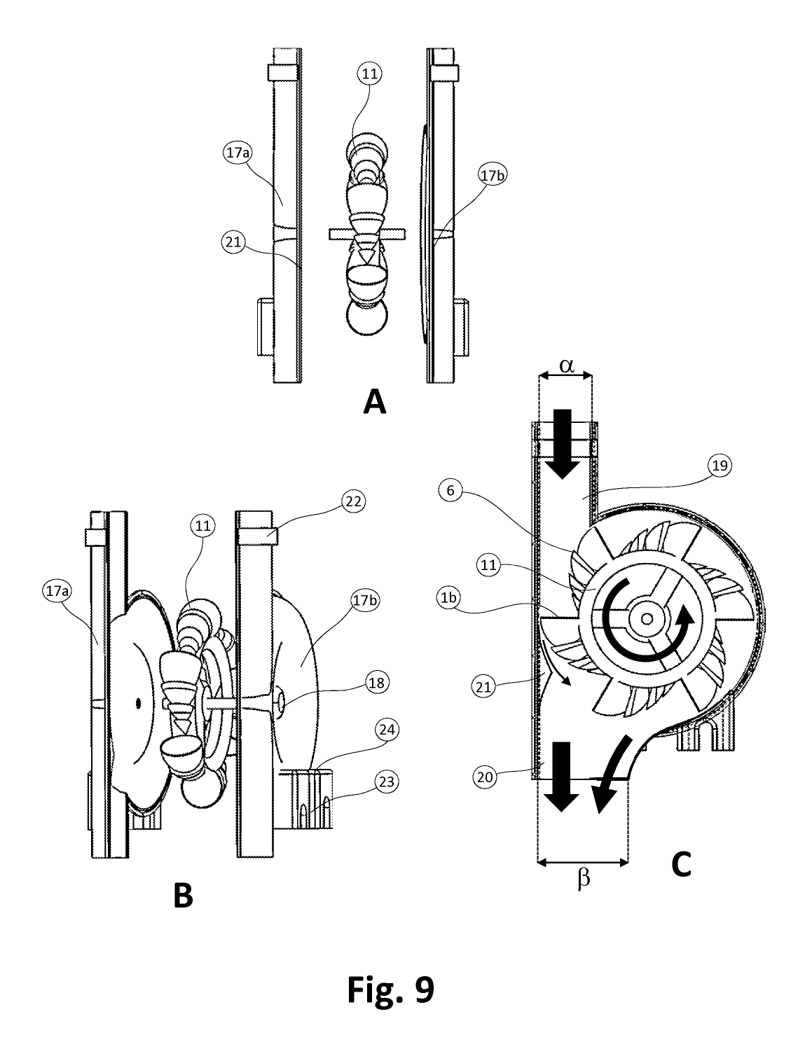

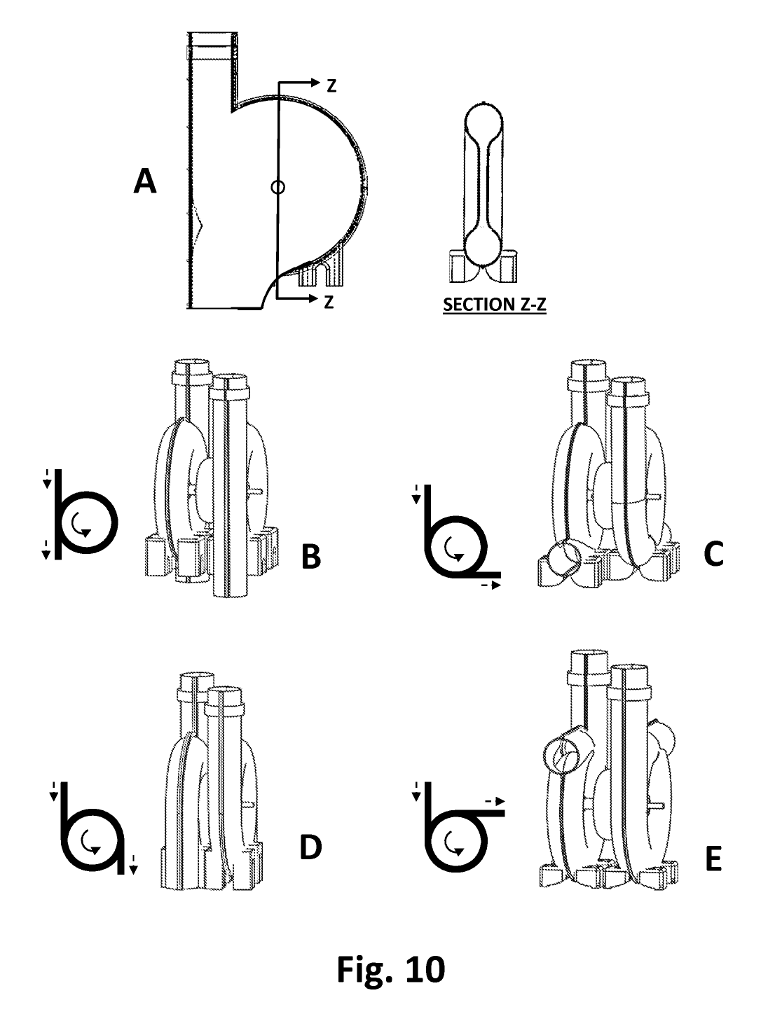

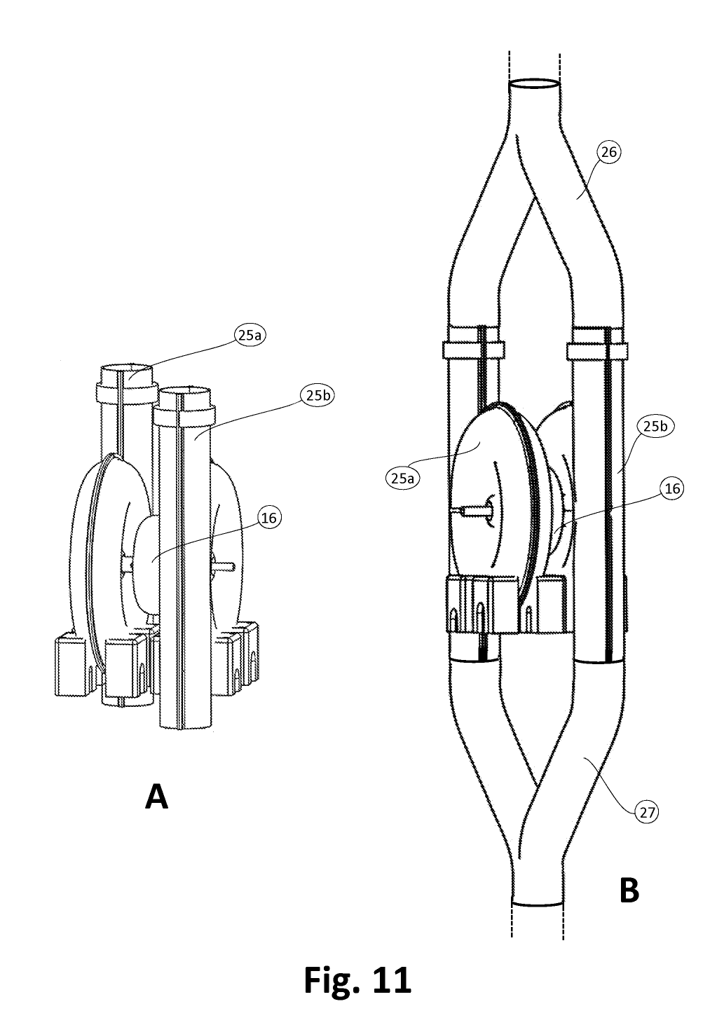

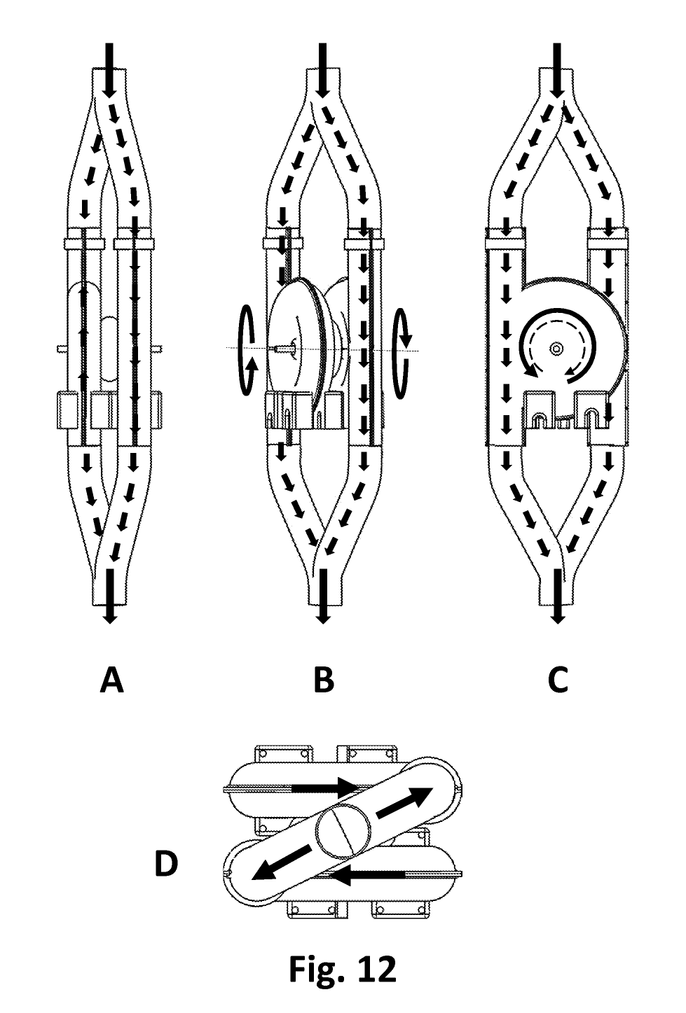

For all these reasons, contra rotating generators are ideal for implementation in highly populated areas as urban environments. The double impulse turbine system associates the efficiency of turbine designs and contra rotating generators to provide compact, efficient and reliable hydroelectric generators to be connected to water pipe systems to produce electricity. Because the double impulse turbine system concept could be used in various environments to harness the energy of fluid in pipe at different velocity, pressure or density, four types of turbine housings have been designed and are disclosed in the FIG. 8 with accompanying schematic fluid path depicted by the black arrows and lines. Thus, are shown a straight housing (FIG. 8(A)) where the inlet and outlet are in straight alignment and attached tangentially to a hollow torus-like body carrying the turbine. This option is proposed to be used in vertical pipes and take fully advantage of gravity driven fluid energy. It is shown in a vertical embodiment. However, it could be adapted for horizontal use as well when the pressure and velocity of the fluid are sufficient. For the right angle low outlet housing (B), the inlet and outlet form a right angle. The outlet is tangentially connected to the lower side of the housing body. This housing option is proposed to be used in pipe elbow to reduce the loss due to friction and extend the thrust of the fluid on the turbine buckets. In ideal embodiment, the outlet is connected to the hollow torus-like turbine carrying body with an angle of 30 degree relative to the vertical inlet which enables to extend the thrust of the fluid flow on the turbine buckets with a minimum friction loss of the fluid on the internal walls of the pipe outlet. The length of the fluid thrust on the turbine buckets is further extended with the anti-parallel (C) and right angle high outlet (D) housings. For the anti-parallel housing, the inlet and outlet connecting pipes are fused tangentially to the opposite sides of the housing body. For the right angle high outlet housing, the inlet and outlet form a right angle. The outlet is tangentially connected to the top side of the housing body. The anti-parallel and right angle high outlet housings are designed to extract the energy of gaseous fluids flowing in pipe because in these options the thrust of the fluid on the turbine buckets is extended. The housings are shown with their two covers (17a and 17b) fastened to each other in working configuration. These turbines housings are designed to carry the turbines of the double impulse turbine system used in various environments. The body of the housings has lateral and centrally positioned holes (18) with bearing units to enable the turbine shafts to rotate smoothly. The inlets (19) and outlets (20) are tangentially connected to the housing circular hollow body designed to carry the turbines. The angles between the inlet and the outlet are disclosed as illustrative examples. Same, the outlet are shown straight. However, because, fluid escaping from the housing body is not straight, the outlets could be curved to reduce the friction of the fluid. More, because the energy of the fluid is extracted by the turbine enclosed inside the housings, its velocity is reduced at the outlet compared to the velocity at the inlets. To prevent the accumulation of the fluid in the housing body, the diameter of the outlets is bigger than the diameter of the inlets. The FIG. 9 depicts in detail an open straight housing with a scaled horn-bucket turbine (11) positioned between its two covers (17a and 17b) in a front (A) and isomeric (B) view while the FIG. 9(C) shows a side view of the housing without the right cover to illustrate the central position of the turbine. The turbine is positioned in such way that its bucket inlets (1b) face the incoming flow of the fluid, depicted by the dark bold arrow. Because the inlets of the bucket fit the circular cross section of the housing inlet, the fluid flow thrust is fully transmitted to the turbine buckets. This view also illustrates the role of the scales (6) on the scaled horn-bucket surface. Thus, while the main inlet of the following bucket is not yet facing the descending fluid flow, the fluid thrust is already transmitted to the turbine by the scales of the bucket facing the fluid flow. This additional thrust increases the torque of turbine and so its efficiency. For the straight housing, the side view shows a deflector (21) with a curved surface to orient the incoming flow from the housing inlet toward the buckets of the turbine for additional thrust. The connection of the housing inlet to a pipe is provided by an attachment dispositive (22). Obviously, such dispositive, not show in the illustrations disclosed here for the commodity of view, is also present at the end of the outlets. As mentioned above, the diameter of the housing inlet (19), depicted by a, is smaller than the diameter of the outlet (20), depicted by β, to enable a fast discharge of the fluid inside the housing body and thus prevent its flooding or backflow due the reduction of the velocity of the fluid flow generated by the extraction of its energy by the turbine. In operation, to assure the stability of the system, the housing is attached to the ground or a support by anchoring legs (23) with holes for fasteners (24). The housing body is further described in the FIG. 10(A) showing its cross section. This view illustrates the torus-like shape of the body with a central planar and circular part for the path of turbine spokes. Thus, the turbine buckets rotate in the circular external part of the body while its spokes rotate in the central planar part. This design enables the fluid flow entering in the housing body to circulate mostly at the periphery where are positioned the turbine buckets to give maximum torque to the turbine. The FIG. 10 shows also isomeric views of double impulse turbine systems using straight (B) right angle low outlet (C), anti-parallel (D) and right angle high outlet (E) housings. These views depict the opposite orientation of the housings and the central position of the contra rotating generator in its housing. To operate, the double impulse turbine system is connected to a piping system carrying the fluid flow. The FIG. 11 shows isomeric views of a double impulse turbine system with straight housing before (A) and after (B) connection. The connection to the turbine housings (25a and 25b) to a piping system is provided by a “Y” inlet connector pipe (26) and a “Y” outlet connector (27). The FIG. 12 shows a front (A), isomeric (B), side (C) and top (D) views of a double impulse turbine system with straight housings in operation and the path of the fluid flow depicts by the dark straight bold arrows. Thus, the main incoming flow is equally divided by the “Y” inlet connector into two secondary flows toward the inlets of the turbine housings. These secondary flows reach tangentially the turbines inside the housings in opposite positions to transmit their energy. After the energy of the fluid flow is extracted by the turbines, coaxially connected to the contra rotating generator, the tail flow is discharged and merged in the “Y” outlet connector attached to the connected pipe.

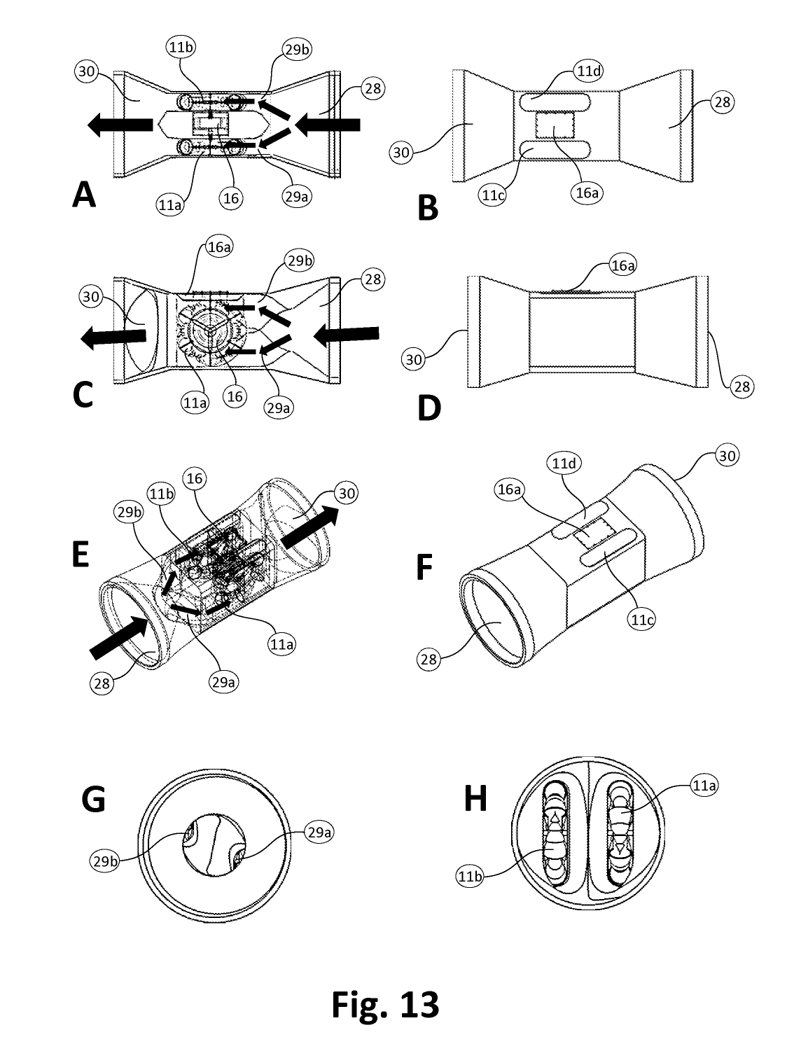

To enable a fast installation for small units in small scale piping systems, a compact version of the double impulse turbine system is provided. The FIG. 13 illustrates detailed views of this compact version. This figure shows both transparent (A, C, and E) and external (B, D, and F) views of the system in top (A and B), side (C and D) and isomeric (E and F) external views. The transparent views illustrate the relative locations and positions of the parts of the system and the fluid circulation depicted by the back bold arrows. The system has an inlet (28) through which enters the incoming fluid flow which is equally divided into two secondary flows oriented, by two internal channels (29a and 29b), toward two turbines (11a and 11b) installed in opposition and coaxially connected to a contra rotating generator (16). After passing and transmitting their energies to the turbines, the secondary flows are discharged into the outlet (30). The external views show the compact double impulse turbine system depicting the locations of the covers of the turbines (11c and 11d) and generator (16a). A front view (G), showing the system inlet and back view (H) showing its outlet illustrate the orientations of the internal canals (29a and 29b) as well the opposite orientation of the turbines (11a and 11b).

With non-compact and compact versions, the double impulse turbine system associated with the variety of turbines and housings disclosed, this system can be adapted for use in a wide variety of environments, fluid flows or configurations and sizes.

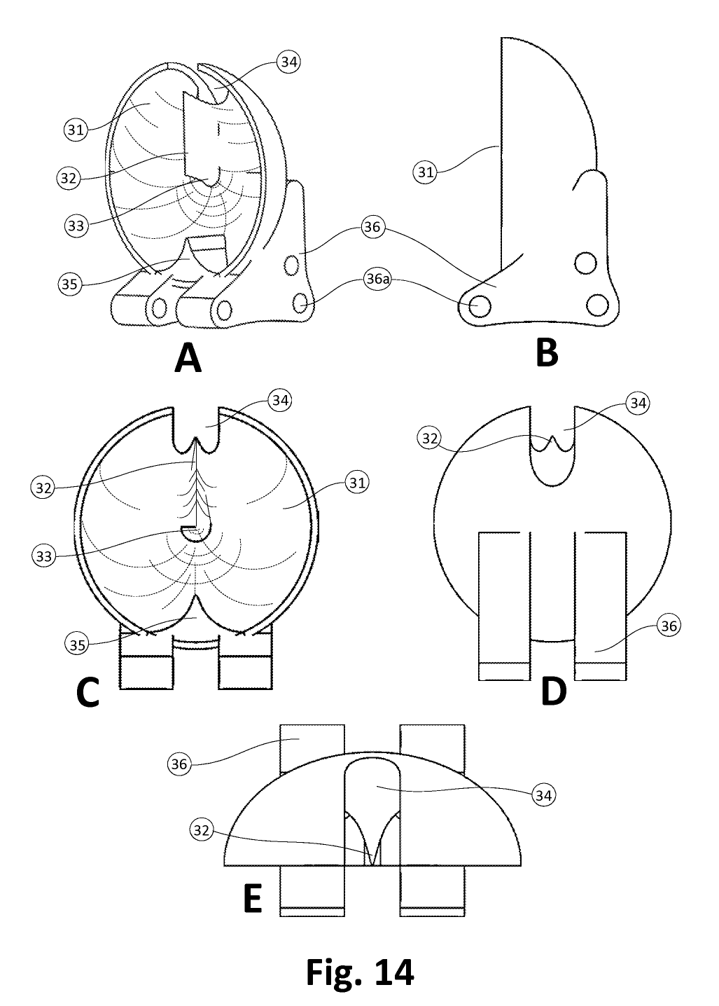

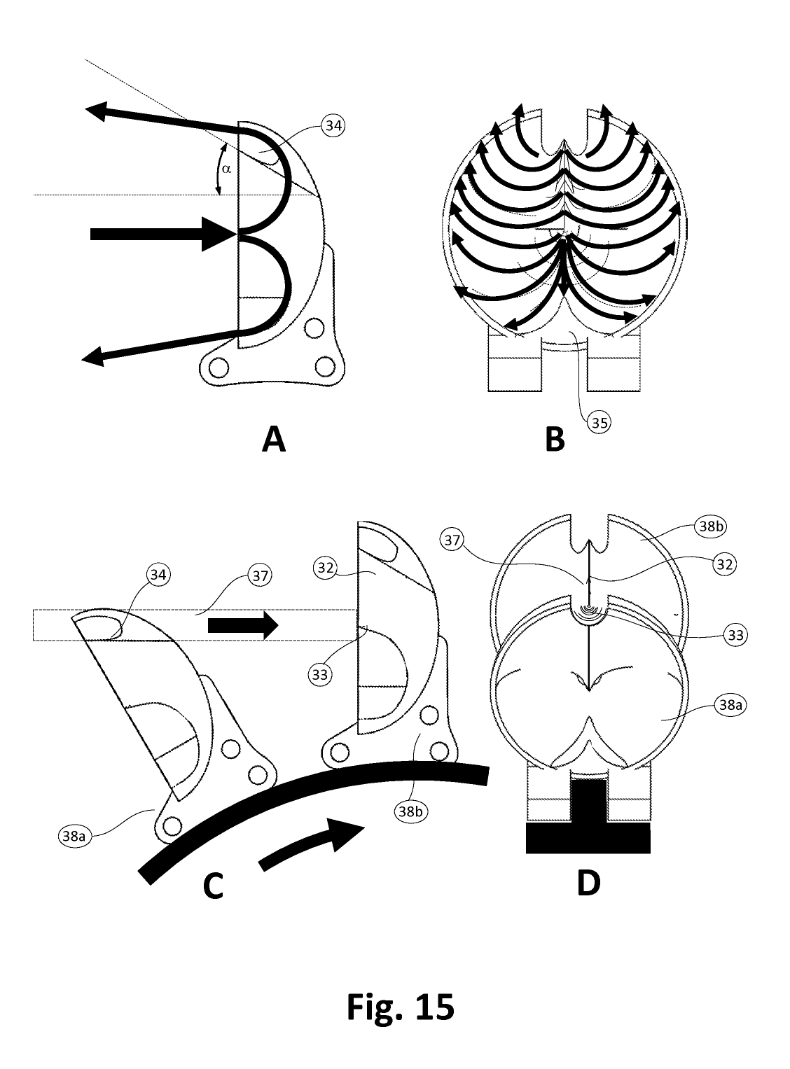

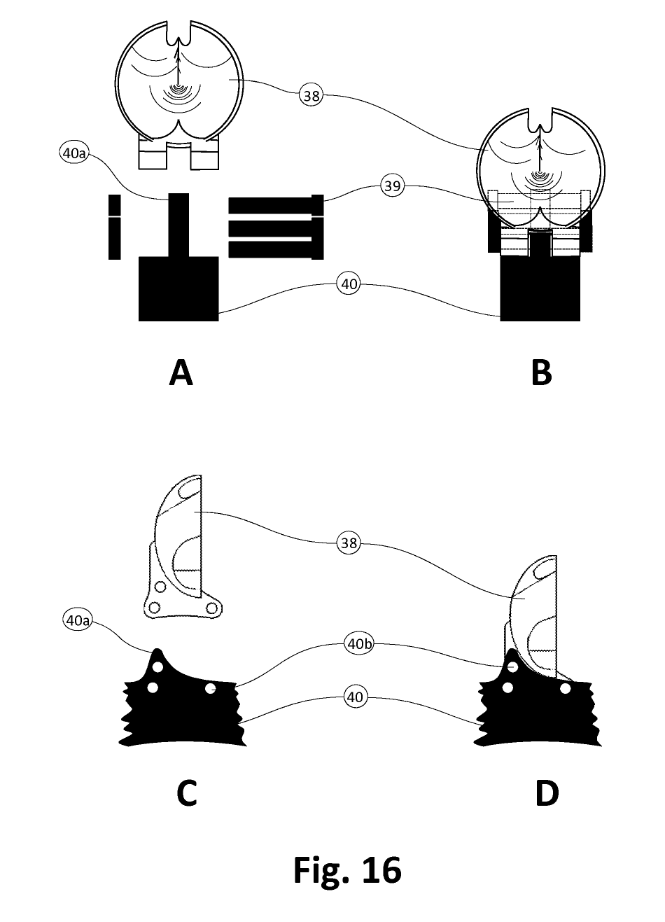

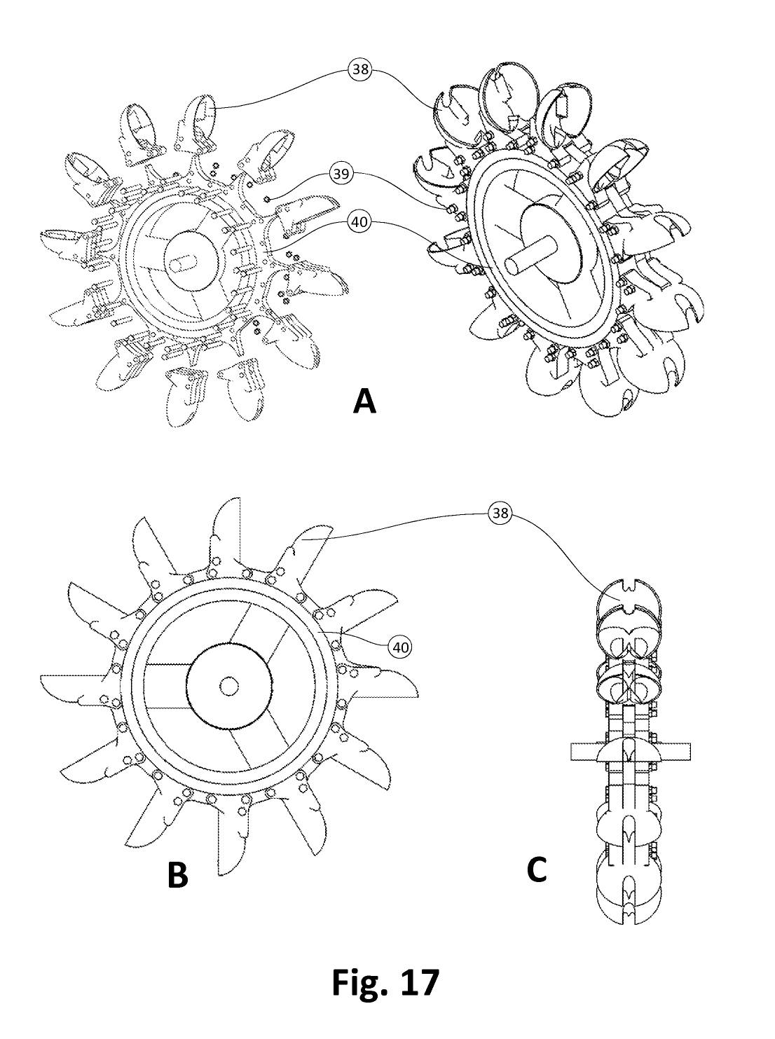

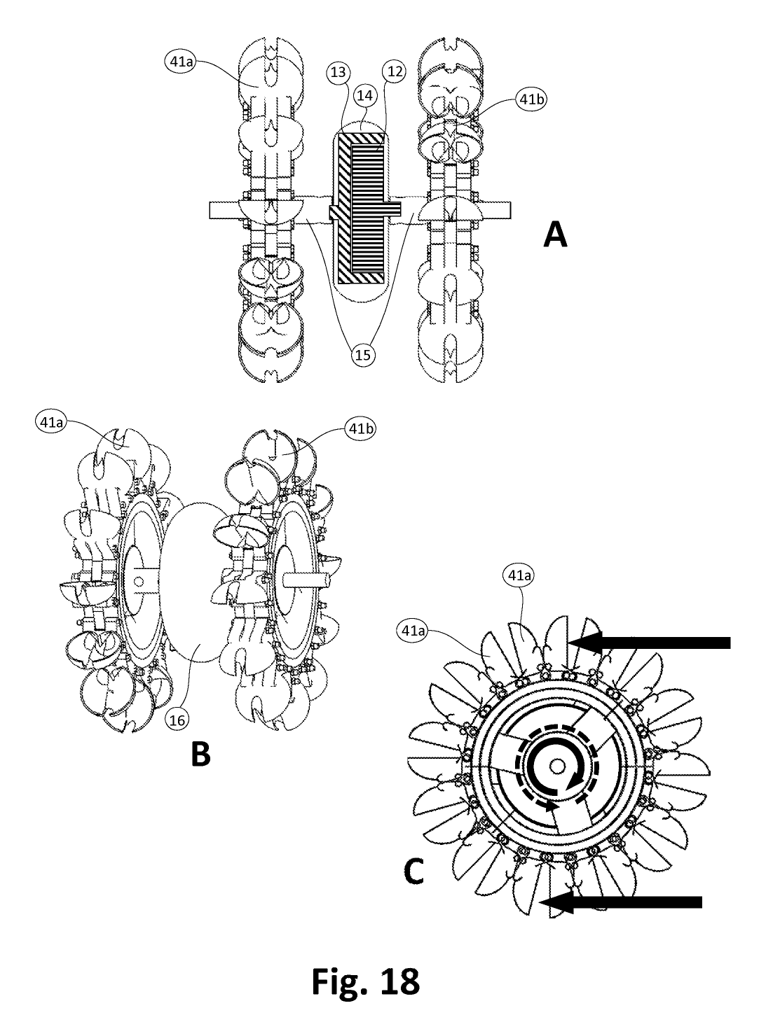

The double impulse turbine system disclosed above describes a system to harness the energy of a fluid flowing inside a pipe and convert it into electricity. For high head and slow flow existing in environments with high angle slope such as in mountain areas or dams, a new impulse jet turbine is proposed to be adapted for the double impulse turbine system. The FIG. 14 shows a bucket to be used with this turbine in isomeric (A), side (B), front (C), back (D) and top (E) views. The design of this bucket is directly inspired from the buckets used in the well known Pelton wheel invented by Lester A. Pelton and disclosed in the U.S. Pat. No. 233,692 in October 1880 and improved in the U.S. Pat. No. 409,865 in August 1889. The Pelton turbine bucket is characterized by a flat face, and upon this face is secured peculiar-shaped buckets adapted to receive the water stream from a nozzle and divide it, so that the two part of the stream are directed into the curved bottoms of the two halves of the bucket, and by means of the inclined or flaring side, the two streams react and escape smoothly at each side. Thus the whole reactionary force of the water is utilized, and the water is discharged clear of the turbine. Since then, several various improvements have been made to this design. However, they suffer from the fact that the jet stream is oriented only toward the top of dividing central splitter of the turbine buckets which enables a smooth escape of the jet stream at each side of the bucket but does not catch its full potential energetic. In the invention disclosed here, the bucket has also a concave internal face (31) and a central dividing splitter (32). However, in contrary to the Pelton bucket, the splitter does not cross all length of the bucket but is merged with a semi-conical deflector (33) having its pic positioned at the center of the bucket. A path (34) at the center top of the bucket enables the jet to reach the following adjacent bucket. At the bottom of the internal concave face of the bucket, a defector (35), substantially triangular enables the fluid jet to escape laterally and backwardly both sides of the bucket. The bucket is mounted on the turbine rim through a set of two anchoring legs (36) with holes (36a) for fasteners. Thus described, the functions of the bucket design are illustrated in the FIG. 15 showing a single bucket in transparent side view (A) and an external front view (B). The side transparent view depicts the angle (α) of the top jet path (34) with a horizontal imaginary line. The jet path has a semi cylindrical base prolonged by two vertical walls. The jet path cuts through the bucket body and the top of the jet dividing central splitter at the internal face. The path of jet hitting the surface of the bucket is illustrated by the black bold arrows to depict its deflection. As shown in the front view (FIG. 15(B)), the jet is deflected on the totality of the bucket surface. From the top to the center of the bucket, the jet is deflected laterally by the central splitter as in a Pelton bucket. When it reaches the center of the bucket, the jet is deflected radially on the surface of the bucket. The bottom deflector (35) enables a lateral deflection of jet radially deflected by the semi conical deflector. Thus, in contrary to a Pelton design where the jet is divided equally on all surface of the bucket, in the design disclosed here, the deflection is lateral in the top half and radial in the bottom half of the bucket. Another fundamental difference between these two designs is illustrated by the FIG. 15(C) and Fig. (D) showing a side and front views of two adjacent buckets respectively. The fluid jet (37) passes through the jet path (34) at the top of the first bucket (38a) and strikes frontally the second bucket (38b) at its center where the central splitter (32) is merged into the conical deflector (33). This frontal strike followed by a combination of lateral and radial backward deflection enables a maximum energy transfer of the fluid jet to the turbine which increases its efficiency. Moreover, because of the top path enabling the jet to pass through a bucket to be deflected on the surface of the one behind it, the time gap between two next adjacent buckets is virtually eliminated. This enables to build turbines with a limited number of buckets and thus save material, cost and time during maintenance or replacement. The steps of the installation of a bucket on the turbine rim are illustrated in the FIG. 16 by front (A and B) and side (B and C) views. The FIG. 16A shows a front view of a bucket (38) and a set of three fasteners (39) before installation on the turbine rim (40) with a bucket support (40a). As shown by the FIG. 16(B), the bucket is installed by sliding its two anchoring legs (36) both sides of bucket support (40a) to enable the fastening with the set of the three fasteners (39). The bucket installation is further described by the side views illustrated by the FIG. 16(C) and FIG. 16(D). In these views, the installation of the bucket (38), shown here in transparency, is performed by aligning the holes (40b) crossing the bucket anchoring legs to the holes crossing the bucket support (40a) before fastening. In this position, these views reveal the generally triangular shape of the bucket support (40a) with one rounded face complementary to the external back face of the bucket (38). With tight fixation provided by three fasteners, the attachment and stability of each bucket to the turbine is secured also by this back support provided by the bucket support. This simple procedure enables a fast and secure way to install or replace a bucket during maintenance or construction. The FIG. 17 shows an exploded (A) and assembled (B) isomeric views of a turbine to illustrate the small number of parts to put together to build a full working turbine. Thus, in the embodiment disclosed here, the turbine has only 12 buckets (38) requiring a set of three of fasteners (39) for each to enable installation on the turbine rim (40). The additional side (C) and front (D) views illustrate the alignment of the buckets (38) on the turbine rim (40) and, more importantly, the orientation of the bucket inlets. The buckets are oriented in such way that an imaginary line passing through the pic of the central semi conical bucket inlet deflector, merged to the base of the central dividing splitter, is tangential to an imaginary concentric circle relative to the turbine rim. Although the new impulse turbine disclosed here can be used with a conventional generator, it is designed to be used in a double impulse turbine system. In this configuration, as shown in the FIG. 18 by frontal (A), isomeric (B) and side (C) views, the shafts of two turbines (41a and 41b) are coaxially connected, through two connecting systems (15), to the shaft of the power-producing component (12) and contra rotating magnetic field component (13) of the contra rotating generator enclosed inside a housing (14). Thus, in working configuration, two turbines (41a and 41b) are coaxially connected in opposite orientations to a centrally positioned contra rotating generator (16) in such way that the buckets of each turbine are impacted by two pressurized airborne water jets oriented tangentially to the turbines. As illustrated in the FIG. 18(C), showing a side view of a double impulse turbine system, the two water jets depicted by the dark black arrows, are oriented tangentially at the opposite sides toward the buckets of the turbines (41a and 41b). In working configuration, the turbines are installed on a supporting structure which enables their smooth and secure rotation. The double impulse turbine system with the new designed impulse turbine described would be ideal to be used in high head water pressure with a contra rotating generator. To increase the performance of the system, several injecting water jets can be used for each turbine as in existing hydroelectric plants using Pelton wheels.

The information provided above is illustrative of the present invention and is not intended to be limiting. Various modifications to the present invention will be readily apparent to those of skill in the art upon reading this disclosure. It is contemplated that such modifications are within the spirit and scope of the present invention. Thus, it will be appreciated that various modifications may be made to the foregoing embodiments within the scope of the present invention. For example, the system may comprise more than one turbine each side of the contra rotating generator to be used in wider fluid flow. An electronic control unit may be added to optimize the system electric output performance. The connection between the turbines and contra rotating generator may be accomplished through gearboxes. The connection between the turbines and contra rotating generator may be accomplished through torque converters. The turbine housings may have top opening rather than lateral opening. The turbine housings may have more than one inlet connector. Each jet turbine may be impacted by more than one water jet. Further, although in the disclosed embodiments is advantageous of circular cross-section, the turbine housings may have non-circular cross section to adapt the system for particular uses.

1. A double impulse turbine system for generating an electric current comprising:
a supporting structure to carry a unidirectional turbine;
a contra rotating generator (16) with a power-producing component (12) and a magnetic field component (13) coaxially rotating in opposite directions to generate electricity;
a substantially cylindrical fluid orienting structure (26) to separate a single fluid flow into equal secondary fluid flows;
a substantially cylindrical fluid collecting structure (27) to merge at least fluid flows into a single fluid flow;
at least two unidirectional turbines with a central drive shaft (5), each arranged on the said supporting structure to rotate in opposite directions when exposed to the secondary fluid flows from the said fluid orienting structure;
two connector units (15) with two attaching ends, the first end of the first said connector rotatably attached to the drive shaft of the first said unidirectional turbine, the second end of the first said connector rotatably attached to the magnetic field component (13) of the said contra rotating generator (16), the first end of the second said connector rotatably attached to the drive shaft of the second said unidirectional turbine, the second end of second said connector rotatably attached to the power-producing component (12) of the said contra rotating generator (16), such that torque generated by the rotation of each of the said unidirectional turbines can be transmitted through the said connector units (15) to the magnetic field component (13) and power-producing component (12) of the said contra rotating generator (16) when the said unidirectional turbines are exposed to the secondary fluid flows from the said fluid orienting structure (26).

2. A double impulse turbine system as recited in claim 1, wherein said supporting structure (25) comprises circular tubular housing body with a flatten center with a central hole (18) and substantially circular cross section at the periphery, tangentially connected to at least one tubular inlet pipe (19) and tangentially connected to one tubular substantially cylindrical outlet (20) such that a fluid flow entering by the said tubular inlet is oriented inside the said circular tubular body and discharged through the said tubular outlet (20).

3. A supporting structure as recited in claim 2, wherein at least one tubular inlet is a substantially cylindrical pipe tangentially connected to the said circular tubular housing body and has at the opposite end a fluid tight connecting mechanism (22) to assure the continuity of the fluid flow with a pipe connected to it.

4. A supporting structure as recited in claim 2, wherein a tubular substantially cylindrical outlet (20) is a pipe, with a bigger cross section than the said tubular substantially cylindrical inlet (19), and tangentially connected to the said circular tubular housing body and having at the end a fluid tight connecting mechanism to assure the continuity of the fluid flow with a pip connected to it.

5. A double impulse turbine system as recited in claim 2, wherein said tubular substantially cylindrical inlet (19) and the said tubular substantially cylindrical outlet (20) are aligned in continuity to form a continue tubular pipe tangentially connected to the said circular tubular housing body;
the continue tubular pipe has on the internal face a generally triangular cross section deflector (21) with a curved surface such that a fluid flow entering by the said tubular substantially cylindrical inlet is deflected toward the buckets of the said unidirectional turbine.

6. A double impulse turbine system as recited in claim 2, wherein said tubular substantially cylindrical inlet is tangentially connected to the said circular substantially cylindrical tubular housing body and the said tubular substantially cylindrical outlet is tangentially connected to the bottom side of the said circular tubular housing body with an angle of 30 to 90 degree relative to the said tubular substantially cylindrical inlet.

7. A double impulse turbine system as recited in claim 2, wherein said tubular substantially cylindrical inlet is tangentially connected to the said circular tubular housing body and the said tubular outlet is tangentially connected at the opposite side to the said circular tubular housing body and parallel relative to the said tubular substantially cylindrical inlet.

8. A double impulse turbine system as recited in claim 2, wherein said tubular substantially cylindrical inlet is tangentially connected to the said circular substantially cylindrical tubular housing body and the said tubular substantially cylindrical outlet is tangentially connected to the top side the said circular tubular housing body with an angle of substantially 90 degree relative to the said tubular substantially cylindrical inlet.

9. A double impulse turbine system as recited in claim 1, wherein said unidirectional turbine is an turbine with horn-shaped buckets (3) having a substantially concave semi spherical cup inlet (1), a curved body and a smaller substantially circular end (2);
the said horn-shaped bucket are regularly attached to the outer periphery and middle of the rim (4) of the said unidirectional turbine such that the inlet planes of each said horn-shaped bucket are perpendicular to a tangent relative to the rim of the said unidirectional turbine and are at close proximity of the smaller substantially circular ends of the following adjacent buckets;
the spokes (4a) of the said unidirectional turbine has a generally triangular cross section with the pic of the triangle aligned in a plane passing through the middle of the rim of the said unidirectional turbine and oriented toward the smaller substantially circular end (2) of the said horn-shape buckets (3).
the said spokes (4a) of the said unidirectional turbine connect the rim of the said unidirectional turbine to a central flat cylindrical hub (4b) crossed at its center by a rotatable drive shaft (5).

10. A double impulse turbine system as recited in claim 1, wherein said unidirectional turbine is an turbine with scaled horn-shaped buckets (7) having a substantially concave semi spherical cup inlet (1b), a curved and scaled body, and a smaller substantially circular end (2b);
the body of each said scaled horn-shaped bucket has several encircling scales (6) with tapered edges oriented toward the bucket inlet;
the said scaled horn-shaped bucket are regularly attached to the outer periphery and middle of the rim (4) of the said unidirectional turbine such that the inlet planes of each said scaled horn-shaped bucket are perpendicular to a tangent relative to the rim of the said unidirectional turbine and are at close proximity of the smaller substantially circular ends of the following adjacent buckets;
the spokes (4a) of the said unidirectional turbine has a generally triangular cross section with the pic of the triangle aligned in a plane passing through the middle of the rim of the said unidirectional turbine and oriented toward the smaller substantially circular end (2) of the said scaled horn-shape buckets (3).
the said spokes (4a) of the said unidirectional turbine connect the rim of the said unidirectional turbine to a central flat cylindrical hub (4b) crossed at its center by a rotatable drive shaft (5).

11. A double impulse turbine system as recited in claim 1, wherein said unidirectional turbine is an turbine with open horn-shaped buckets (10) having a substantially circular inlet (1c) communicating through a hollow curved body with a smaller substantially circular end ((9);
the body of each said open horn-shaped bucket has on the dorsal face at least one crescent-like opening (8) oriented toward the bucket inlet (1c);
the said open horn-shaped bucket are regularly attached to the outer periphery and middle of the rim (4) of the said unidirectional turbine such that the inlet planes of each said open horn-shaped bucket are perpendicular to a tangent relative to the rim of the said unidirectional turbine and are at close proximity of the smaller substantially circular ends of the following adjacent buckets;
the spokes (4a) of the said unidirectional turbine has a generally triangular cross section with the pic of the triangle aligned in a plane passing through the middle of the rim of the said unidirectional turbine and oriented toward the smaller substantially circular end (2) of the said open horn-shape buckets (3).
the said spokes (4a) of the said unidirectional turbine connect the rim of the said unidirectional turbine to a central flat cylindrical hub (4b) crossed at its center by a rotatable drive shaft (5).

12. A double impulse turbine system as recited in claim 1, wherein the said unidirectional turbines are turbines (41a and 41b) with a plurality of cup buckets (38) regularly mounted on a rim (40) of the said unidirectional turbine such that the inlets (31) of the said cup buckets are perpendicular relative to the plane of rotation and tangential relative to the rim circumference, where each said cup bucket is fastened to a substantially triangular protruding bucket support (40a) in the middle of the rim by three fasteners (39) passing through three holes (40b).

13. An unidirectional turbine as recited in claim 12, wherein the said cup buckets (38) have a substantially circular inlet (31) and a substantially semi-spherical outer surface with two substantially triangular anchoring legs (36) inserted at either external sides and crossed by three fastening holes (36a);
the internal face of the said cup buckets has in the half top part two substantially semi-circular curved bottoms that meet to form a sharp ridge splitter (32) in the middle of the said cup bucket (38) and merge at the center of the said cup bucket with the pic of a semi conical deflector (33) having a radial substantially semi-circular bottom that merges with the bottom of the two substantially semi-circular curved bottom of the half top part;
the substantially semi-circular curved bottoms of the sharp ridge of the half top part and semi conical of the half bottom part of the internal face of the said cup bucket are merged to form an unique curved continuous smooth surface with inclined discharge sides;
the bottom internal face of the said cup buckets, has a substantially triangular cross section deflector (35) merged into the internal face such that the lateral faces of the triangle are curved and meet to form a sharp ridge aligned with the said splitter (32) of the half top;
a jet path (34) with a substantially semi cylindrical bottom prolonged on the sides by two substantially vertical walls crosses the top part of the body of the said cup bucket and the middle of the said splitter (32) with an inclination angle relative to horizontal such that a jet stream can pass through a said cup bucket to strike the inlet surface of the following adjacent said cup bucket (38).

14. cup buckets as recited in claim 13, wherein the said cup buckets (38) are aligned on the middle of the rim of the said unidirectional turbine such that a fluid jet stream oriented tangentially to the said unidirectional turbine passes through the said jet path of a said cup bucket to strike the said middle splitter (32) with an angle relative to horizontal and then perpendicularly the junction of the said middle splitter with the pic of the said semi conical central deflector (33) on the inlet surface of the following adjacent said cup bucket to be diverted laterally and backwardly without hitting the back of the following said cup bucket.

15. A double impulse turbine system as recited in claims 1, 9, 10 and 11, wherein the said unidirectional turbine is installed inside a said supporting structure such that the inlets (1a, 1b, 1c) of the said unidirectional turbine buckets (3, 7, 10) are oriented toward the entrance of the inlet (19) of the said supporting structure and the drive shafts of the said unidirectional turbine inserted in the central holes (18) of the said housing body such that a fluid flowing from the inlet (19) of the said supporting structure is directed toward the inlets (1a, 1b, 1c) of the buckets (3, 7, 10) of the said unidirectional turbine.

16. A double impulse turbine system as recited in claims 1 and 15, wherein two said supporting structures carrying each a said unidirectional turbine are installed side by side in opposite directions such that the drive shaft of one said unidirectional turbine is rotatably attached through the said connector (15) to the said power-producing component (12) of a said contra rotating generator (16) and the drive shaft of the other said unidirectional turbine is rotatably attached through a connector (15) to the said a magnetic field component (13) of the said contra rotating generator (16) positioned in the middle.

17. A double impulse turbine system as recited in claims 1 and 16, wherein the two said supporting structures carrying each a said unidirectional turbine connected to the said power-producing component (12) and the said magnetic field component (13) of a said contra rotating generator (16), positioned in the middle, have their inlets (19) connected to the said substantially cylindrical fluid orienting structure (26) separating a single incoming fluid flow into equal secondary fluid flows and their outlets connected to the said substantially cylindrical fluid collecting structure (27) merging fluid flows which pass the said unidirectional turbines, into a single fluid flow.

18. A double impulse turbine system as recited in claims 1, 9, 10 and 11 wherein the said two unidirectional turbines (11a and 11b) are installed side by side in opposite directions inside two internal lateral housings (11c and 11d) of a substantially cylindrical structure having a substantially conical shaped inlet (28) connected to two internal channels (29a and 29b) connected tangentially to the superior and inferior sides of the said lateral internal housings carrying the said unidirectional turbines having their respective drive shafts rotatably connected to the said power-producing component (12) and the said the magnetic field component (13) of the said contra rotating generator (16) installed in a central housing such that a fluid flow entering by the said inlet (28) is separated into two secondary fluid flows oriented tangentially toward the inlets of the buckets (3, 7, 10) of the said unidirectional turbines (11a and 11b) rotating in opposite directions is discharged into an substantially cylindrical outlet (30).

19. A double impulse turbine system as recited in claims 1 and 14 wherein the said two unidirectional turbines (41a and 41b) having their respective drive shafts rotatably attached to the said power-producing component (12) and the said the magnetic field component (13) of the said contra rotating generator (16) such that two fluid jet streams oriented tangentially at the opposite sides of the said unidirectional turbines strike the said cup buckets (38) of the said unidirectional turbines to rotate in opposite directions.

20. A double impulse turbine system as recited in all claims above herein described with reference to any one of the embodiment of the invention illustrated in the accompanying drawings and/or examples.
